(19) United States
(12) Patent Application Publication
(10) Pub. No.: US 2017/0169473 A1
(43) Pub. Date: Jun. 15, 2017

(54) App social network via linket and ads for mobile deep links

(71) Applicant: Wesley John Boudville, Perth (AU)

(72) Inventor: Wesley John Boudville, Perth (AU)

(21) Appl. No.: 14/757,261

(22) Filed: Dec. 11, 2015

(51) Int. Cl. G06Q 30/02; G06Q 50/00; G06F 17/22; G06F 3/0482; G06F 3/0484

(52) U.S. Cl. CPC G06Q 30/0267; G06F 3/0482; G06F 3/04842; G06F 17/2235; G06Q 30/0269; G06Q 30/0273; G06Q 50/01

(57) ABSTRACT

A linket is a label for a deep link. A deep link is at minimum 2 items. An app id and a network address where the app is run. A Registry maps from a linket to a deep link. The Registry and linkets define an app social network or a functional social network. This social network is fundamentally about users interacting with each other in real time via mobile apps. Qualitatively different from current personal or professional social networks. The Registry offers business intelligence analysis of the app social network. The Registry shows contextual ads from owners of competing linkets. One context is when a user sends a linket to the Registry to get the deep link. The Registry replies with the deep link and an ad. The Registry can send an ad, akin to an interstitial ad for web pages. Only when the user removes the ad does the Registry send the deep link. Another context is where a linket owner migrates from app Alpha to app Beta. The Registry lets competitors make ads shown to users around the transition. The ads are grouped automatically into cases like where a competitor recommends her linket that continues to use Alpha. Appeals to users reluctant to transition from Alpha. A second case is for a competitor with a linket already using Beta. This competitor can claim to be more experienced with it than the linket owner. A third case is for a competitor with an app different from Alpha or Beta. The Registry can also show ads when a linket is deleted. The ads are for competing linkets. The attraction is that the ads do not have direct competition from the deleted linket.

### REFERENCES CITED

“Apps everywhere but no unifying link” by C. Dougherty, New York Times, 5 Jan. 2015.

“Deep linking's big untapped potential” by M. Thomson, VentureBeat.com, 9 Aug. 2015.

“Generating and presenting deep links” by V. Tankovich et al, US Patent Application 20130110815 (Oct. 28, 2011).

“Methods and systems for facilitating an online social network” by C. Evans, US Patent Application 20140089413 (Dec. 6, 2013).

“Text-synchronized media utilization and manipulation based on an embedded barcode” by C. Evans, US Patent application 20130334300 (Mar. 27, 2013).

“Smart link system and method” by J. Chor, U.S. Pat. No. 8,433,800, (28 Feb. 2011).

“Deep linking to mobile applications” by S. Saxena et al US Patent Application 20150154644 (Dec. 2, 2013).

“Deep linking to mobile applications” by S. Saxena et al US Patent Application 20150156061 (Dec. 2, 2013).

### TECHNICAL FIELD

Deep links for mobile apps.

### BACKGROUND

Mobile apps have a distinctive problem. Most are currently standalone programs that often just converse with an app server run by the company that wrote the app. The apps do not have URL links within them. In general, an app from one company does not interact with an app from another company.

Separately, it is much harder for a search engine, which is optimised to search the Web for webpages, to search arbitrary apps. There is no standard syntax equivalent to an URL or URI to enable this.

To enable such and other functionality in mobile apps has been termed ‘deep linking’ within apps. (The term also has an earlier use that refers to standard web pages and URL links within them. This submission does not use that earlier meaning.)

Major companies have several projects aimed at defining deep links. Facebook Corp. has App Links. Google Corp. has App Indexing and Google Intents. Twitter Corp. has App Cards. Apple Corp. has Apple Extensions. Yahoo has 2 US patents pending. There are also several startups, like Bit.ly, Branch Metrics Corp., Button Corp., Quixy Corp., URX Corp., and Tapstream Corp., each with their own initiatives. The syntax and functionality vary between these company specific efforts.

### SUMMARY

A linket is a label for a deep link. A deep link is at minimum 2 items. An id of an app and a network address or domain where the app is run. Often the app runs on a mobile device. The address is assigned to the device by the wireless provider or WiFi hot spot. A raw address is hard to remember. And it can change as the user moves. A linket functions like a domain name. Stable and easier to remember.

A Registry maps from a linket to a deep link. The analog of the DNS system. But whereas the mapping from a domain to an IP address is expected to be stable over months, the deep link address can change over hours.

The Registry and linkets define an app social network or a functional social network. This social network is fundamentally about users interacting with each other in real time via mobile apps. Qualitatively different from current personal or professional social networks.

The Registry shows ads. One context is when a user sends a linket to the Registry, to get the deep link. The Registry replies with the deep link and an ad. One variant is where the Registry first only sends an ad, akin to an interstitial ad for web pages. Only when the user removes the ad does the Registry send the deep link.

Another context is where a linket owner migrates from app Alpha to app Beta. The owner might tell existing users that the linket mapping has changed. The Registry lets competitors make ads, shown to the user at this transition. The ads are grouped programmatically into cases like where a competitor recommends her linket that continues to use Alpha. Or where another competitor has a linket that uses an app different from Alpha or Beta.

If a linket owner deletes her linket, the Registry shows ads to users sending it the deleted linket. The ads refer to competing linkets teaching the same subject. Some ads use the same app as the deleted linket; other ads refer to different apps. The Registry auctions off these ads. The ad placements are appealing because there is now no competition from the deleted linket.

The Registry offers easy to use web pages or a custom app, to let linket owners write ads.

### BRIEF DESCRIPTION OF THE DRAWINGS

FIG. 1 shows deep links in the prior art and the present submission.

FIG. 2 shows a functional social network.

FIG. 3 shows groupings of ads using the app in a deep link.

FIG. 3A shows apps, linket owners and students.

FIG. 4 shows an ad sent by the Registry to a user who picks a linket.

FIG. 5 shows groupings of ads using a transition between apps in a deep link.

FIG. 5A shows a timeline of the transition.

FIG. 6 shows an ad server making groups of ads.

FIG. 7 shows an advertiser searching for linkets teaching ESL.

FIG. 8 shows linkets transitioning from app Alpha.

FIG. 9 shows a window in which a linket owner can write an ad.

FIG. 10 shows the Registry responding to a deleted linket.

### DETAILED DESCRIPTION OF THE PREFERRED EMBODIMENT

What we claim as new and desire to secure by letters patent is set forth in the following claims.

This submission refers to our earlier submissions to the US PTO: “Cellphone changing an electronic display that contains a barcode”, filed 16 May 2011, U.S. Pat. No. 8,532,632 [1]; “Using dynamic barcodes to send data to a cellphone”, filed 28 Jul. 2011, U.S. Pat. No. 8,348,149 [“2”]; “Transmitting and receiving data via barcodes through a cellphone for privacy and anonymity”, filed 4 Oct. 2011, U.S. Pat. No. 8,707,163 [“3”]; “Colour barcodes and cellphone”, filed 16 Dec. 2011, U.S. Pat. No. 8,821,277 [“4”]; “Mobile device audio from an external video display using a barcode”, filed 25 May 2012, U.S. Pat. No. 8,708,224 [“5”]; “Dynamic group purchases using barcodes”, filed 29 May 2012, U.S. Pat. No. 8,655,694 [“6”]; “Chirp to control devices”, filed 9 Oct. 2012, US patent application 20140098644 [“7”]; “Barcode-based methods to enhance mobile multiplayer games”, filed 22 May 2013, US patent application 20140349746 [“8”]; “Barcode, sound and collision for a unified user interaction”, filed October 2013, US patent application 20150113068 [“9”].

We have these co-pending applications for deep linking:

“Deep linking of mobile apps by barcode, sound or collision”, filed Feb. 18, 2015, U.S. patent application Ser. No. 14/544,763 [“10”],

“Cookies and anti-ad blocker using deep links in mobile apps”, filed Jun. 8, 2015, U.S. patent application Ser. No. 14/545,694 [“11”];

“Blockchain and deep links for mobile apps”, filed Jul. 28, 2015, U.S. patent application Ser. No. 14/756,058 [“12”];

“Different apps on different mobile devices interacting via deep links”, filed Aug. 18, 2015, U.S. patent application Ser. No. 14/756,208 [“13”].

“Linket to control mobile deep links”, filed Oct. 19, 2015, U.S. patent application Ser. No. 14/756,815 [“14”].

“Capacity and automated de-install of linket mobile apps with deep links”, filed November 2015, US patent application [“15”].

We described deep links and ways that these could enhance interactions between two mobile devices near each other. The current submission describes a higher level of use of deep links.

We define some terminology.

This submission is mostly about mobile devices carried or worn by people. The most common mobile device is a cellphone. We take this word to also include “smartphone”. The latter term arose to describe a cellphone that also had a camera and Internet access, when such features were relatively new to cellphones. Other types of mobile devices are tablets, laptops, notebooks, netbooks, PDAs and wearable devices.

We will make frequent references to “app store” and “app server”. Despite the similarity in names, these are different entities. An app store is typically run by a maker of a mobile device (like Apple Corp., Microsoft Corp.), or a provider of an operating system for mobile devices (like Google Corp.). Software companies that make mobile apps submit these to an app store. So users can find the apps in the app store and download them to the mobile devices. An app server is a server run by one of those software companies. A mobile user can use her device browser to go to the website of the app server, to download the app.

When we later describe an instance of an app interacting with an instance of another app, we might say, for brevity, a statement like “the first app interacts with the second app”, when strictly it should be “an instance of the first app interacts with an instance of the second app”. There should be no confusion with the use of the shorter phrase. But when 2 instances of an app interact with each other, a more precise phrasing is needed, like “a first instance of the app interacts with a second instance of the app”.

Related to this is a notational convenience. We shall refer to an app, and call it Alpha, for example, in the text and figures. Sometimes “Alpha” shall mean the app executable. Other times, it shall mean the id of the app, where the id is unique across “all” apps. In turn, “all” might mean across all apps in an app store for a given hardware platform. Or across all hardware platforms.

This submission has the following sections.

1: Earlier submissions;

2: Functional (App) Social Network;

3: Registry and Ads;

3.1: Example of a Linket Ad;

3.2: Linket Changes App;

3.3: Search the Ad Server;

3.4: Write a Linket Ad;

3.5: Location Based Ad Options;

3.6: Block Competing Ads;

4: Linket Owner Actions;

1: Earlier Submissions;

This submission extends our work in submissions 14 and 15. We encourage the reader to read those for a fuller discussion of linkets. In this section, we summarise our earlier work.

The prior art uses “deep link” to mean two apps running on one mobile device. The first app has a deep link which is selectable by the user. When the deep link is selected, something happens to cause the second app to be installed on the device. Since typically the second app is not present. The second app is run, with an input argument which causes it to start up and show a particular item or “page”, rather than just a generic “home page”. The “something happens” refers to different ways that different companies have implemented, to enable this.

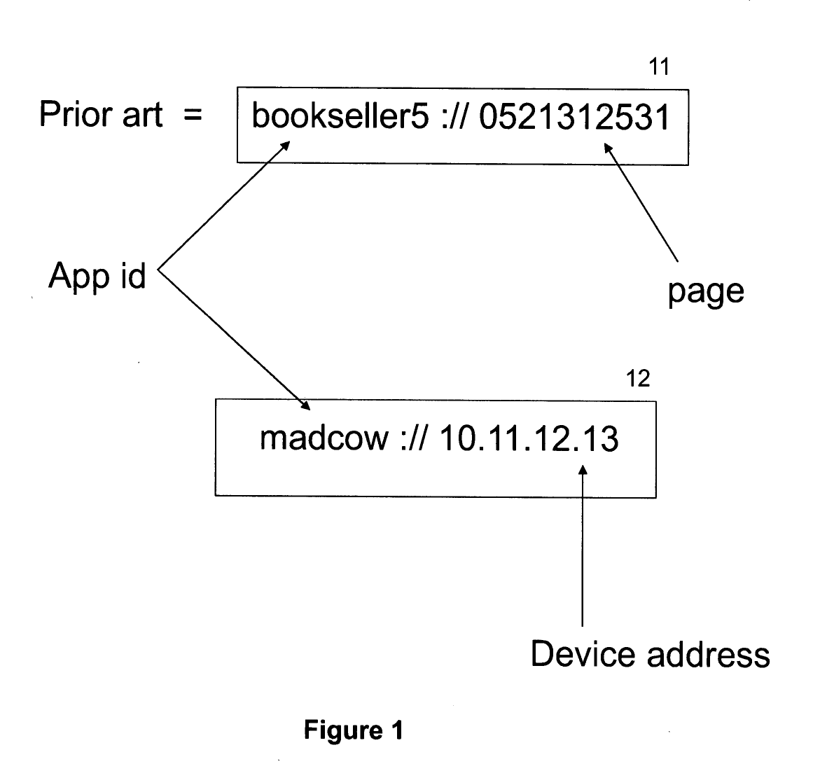

FIG. 1 is FIG. 1 of submission 14. Item 11 is a deep link in the prior art.

Our deep link, as defined in submissions 10-15, is fundamentally different. It lets 2 mobile devices interact. One major category is one app running on 2 mobile devices. By one app, we mean 2 instances of the app. Another category is 2 apps running on 2 mobile devices. One app runs on one device, another app runs on the other device, and the apps interact. Our deep link is for (though not exclusively) multiuser interactions. The category of one app on 2 devices can be for multiplayer games. Or even a single player game, where the second device runs a second instance of the game in spectator mode. The second device screen shows the game window of the first device. But the second device cannot alter. Read only.

Item 12 is a deep link from our submissions. It has an id of an app, “madcow”. It also has a network address, 10.11.12.13, of a device (like a cellphone) running an instance of madcow. Suppose madcow is a two person game. The first person, Jane, has her phone at that Internet address. She starts madcow. She needs a second player. She picks an option in the game that makes the deep link 12. She sends this perhaps via an electronic message (email, SMS etc) to Bob. In general, he does not have madcow installed on his mobile device. He reads the message in a mobile browser. The browser shows the deep link as a clickable link. Bob clicks it. The browser, perhaps in tandem with the device operating system, installs madcow and runs an instance. Giving it the input 10.11.12.13. This tells Bob's madcow instance to connect to another madcow instance at that address, which happens to be Jane's pre-existing madcow instance. Jane and Bob now play the game.

We define a “linket” to be the label of a deep link. The linket can be expressed in Unicode. The linket can be case sensitive. Unlike domain names. This improves the readability of expressions. Case sensitivity is moot for languages like Chinese or Hindi which do not have the concept. The linket can have (but not necessarily) white space.

The linket lets individuals have a personal brand associated with themselves. This follows the observation that many (most ?) people in many countries now have cellphones. A user's cellphone becomes an extension of herself, as has been observed. It is the most common type of personal computer in the world.

Hence a person can own a linket. Of course, a corporation can also own a linket.

Another trend observed is the rise of the so-called gig economy, as exemplified by companies like Uber, Lyft and Airbnb letting individuals offer their services. Where the labour market tends to a friction free state. Our linket and the personal branding it offers is another enabler of the trend. Taken to another level. The linket needs the hardware of a cellphone (or other mobile device). This hardware is cheaper than having ownership of a car or spare bedroom. Thus a linket offers the means for a more widespread use compared to those other firms.

For descriptive simplicity in what follows, we shall write the linket as a string enclosed in quotes. This is meant to describe its string contents in an understandable way independent of a choice of format.

2: Functional (App) Social Network;

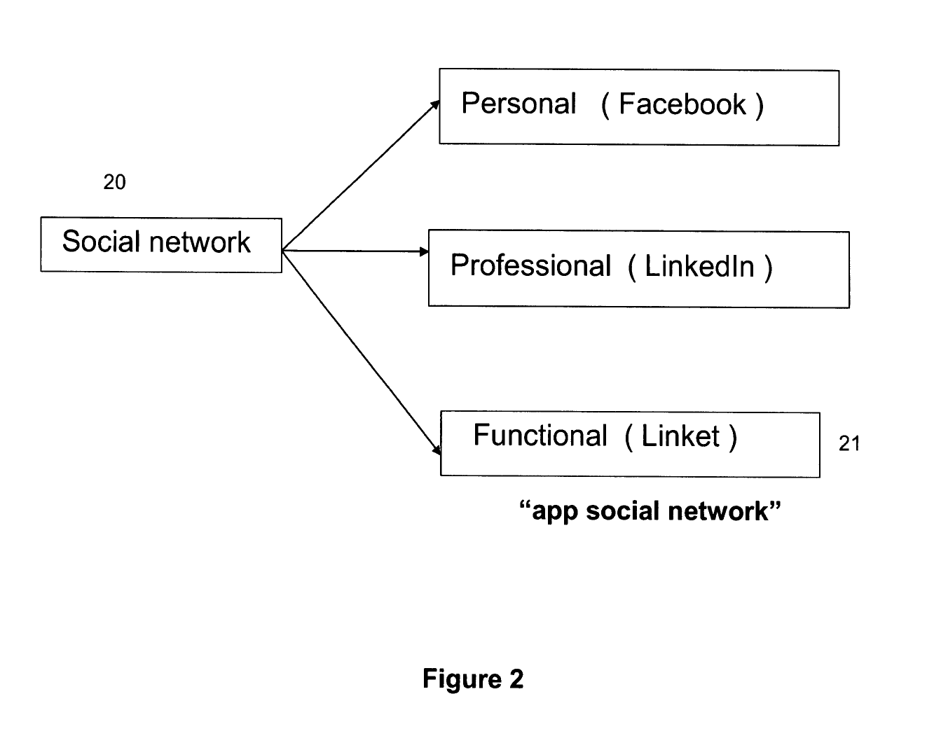

FIG. 2 shows a taxonomy of social networks. Item 20 is the base type of all social networks.

It has 3 children. One child type is a personal social network. The best example is Facebook. Another child type is a professional social network. Linkedln is the largest such instance. What is new is a functional social network in item 21, with the example of the linket. The previous submissions 14 and 15 and this submission explain why the use of the linket makes a social network.

We term it a “functional” social network because it refers to the use of apps on devices that are typically mobile devices. An alternative label for item 21 might be an “app social network”.

We term it a functional “social” network because “social” refers to the most common use cases of at least 2 humans interacting in real time with each other via their mobile devices. Though we include occasional cases where a human with her device might interact with a machine that is not actively controlled by another human. See for example section 7, “Person to machine (p2m) Interaction” of submission 15.

Fundamentally, the linket app social network exists because users make linkets as their personal or professional brands for interactions via mobile devices. A key value of a linket is that it is constant over time, though the underlying network addresses change as the user and her mobile device move.

A point about FIG. 2 is that the distinctions between the 3 types are not absolute. There can be overlap. As we discussed in submission 14 and 15, a person can use a linket for her personal recreational brand. For example, a good player of a game app can advertise herself this way. She can also have another linket for her professional brand. Where this maps to another app that lets her teach a subject to students.

A qualitative distinction between the app social network and the two other types is that the former can be found largely by programmatic means by the Registry. In contrast, when a person makes or updates her Facebook or Linkedln page, all the changes are done manually by her. She explicitly and manually has to do this to document her social network. In contrast, the app social network does have her do explicit steps, using a linket or deep link. But these are steps she does anyway, to use an app to (typically) connect to another person. She does not have to do specific steps to describe her app social network. The Registry finds her app social network via automated ways. Hence the app social network is largely an automated overlayer that can be found from analysis of data about users using linkets and deep links.

The Registry permits the analysis (business intelligence) of how people interact with apps. The later sections of this submission describe how contextual ads can be built into this social network. These provide multiple revenue sources for the Registry. In turn, the deployment of such ads increases the use of linkets and deep links and more data for the social network.

Another point is to contrast the social network data found via the linket and Registry with existing (prior art) social network data from the use of mobile apps. The latter is restricted to the app servers for each app. Often, the social aspect of the data might come from a multiuser app. The users are expected to have somehow heard of the app and pre-installed it on their mobile devices. Then a user runs the app and connects to the app server. Via the server, she is put in contact with other users. There is no deep link mechanism like ours.

But at least in the context of this section, there is another more important difference. Each company that runs an app server decides how much if any of that data to show the world. Different companies have different policies about exposing the data or summary statistics based on it. Each app and its users and data about the use lives in its own walled garden. Outsiders who get any access to the usage data might also wonder about the validity of the data. Has the company “tweaked” the data for favorable impressions?

By contrast, our Registry offers data and analysis across all apps that use it. As should have been clear from our previous 2 submissions on linkets, this spans all topics that apps can be written for. The uniformity of the Registry data access greatly aids an analyst wanting to see a broad picture about multiuser interaction. Also, the Registry acts as an impartial referee. It is independent of any app company.

3: Registry and Ads;

A Registry can be compared to DNS and to a search engine. For actual DNS organisations, the revenue is through fees they charge people who buy domain names and ISPs who host domains. A search engine can make its revenue through ads, especially contextual ads. The latter are ads related in some way to the search term.

The Registry can charge fees to users in several ways. First, to a user who defines a linket, but has not yet mapped (“hosted”) it to a deep link (or another linket). Second, to users who make that mapping. Both are equivalent to how DNS entities function.

The Registry can also show ads. One way is when a user sends a linket to the Registry and wants the deep link it points to. The reply can include an ad. This can occur in several ways.

In what follows, the reader should keep in mind the distinction between two linkets and, more importantly, two deep links. One linket is what the user sent to the Registry. Call it Aleph. The user wants its deep link, Beth. The other linket is what is shown in an ad. Call this linket Daleth. This maps to a deep link Gemel. Daleth competes with Aleph. The owner of Daleth wants the user to ultimately use Gemel instead of Beth. So that the user interacts with the owner of Daleth.

First, the reply is one message, containing both Beth and the ad. The problem is that the user can disregard the ad. Or the software on her device might be able to not show the ad.

Second, the reply comes as two messages. The first message is the ad, which is shown on the user device. She has to do some action, like click on a first button in the ad, where there might be 2 buttons in the ad. This action sends a signal back to the Registry, which then sends Beth in the second message. This first message ad is equivalent to an interstitial ad in the language of webpages. Harder for the user to ignore. Though it may still be possible for her device to automatically do an action to remove the ad and get Beth for the original linket.

If the user clicks the second button, which means she is interested in the linket of the ad, a signal is sent back to the Registry, which sends Gemel in the second message. Or the ad might have that when the second button is clicked, the ad contains already the deep link Gemel, and this is executed on the user device. Without the ad on the user device having to contact the Registry for Gemel.

The ad itself could and should be related to the topic of the linket Aleph that the user sent to the Registry. A contextual ad. This increases the chances that the user seeing the ad will take the action desired by the ad author.

The Registry can avail itself of any knowledge of keywords in a linket description that might have been sent to the Registry by the linket owner. The Registry could serve ads related to those keywords. In related ways, the Registry could run an automated auction (like Google) that lets others bid on showing ads related to a keyword or phrase.

If there are several ads, each can preferably have a linket made by a competitor to Aleph. Each linket might be accompanied by a short description to interest the user. The description could be a combination of text, audio and video. Though as a practical matter, the total size of the ad should be kept small, due to bandwidth constraints of the mobile wireless device. If the user picks one of these linkets, then the Registry returns the corresponding deep link. In this case, the Registry would not return the deep link corresponding to the original linket sent by the user.

One configuration is where one ad is sent to the user device. If the user clicks the first button, this means she is not interested in the ad. Then the Registry sends the second ad, etc. If she clicks the second button in an ad, this means she is interested in that ad's linket, so its deep link is sent from the Registry and no more ads are sent. If she keeps clicking the first button in each ad, then eventually all the ads are shown, and the Registry finally sends her the deep link corresponding to the first linket, Aleph.

A variant is where multiple ads are sent in the same message to her device. Which then shows all the ads in one window. Each ad has a button to send her its deep link. While there can be a (final) button that if clicked means she is not interested in any of the ads. This causes the deep link corresponding to Aleph to be sent to her device.

A variant is where if the ad already has the deep link, then if the user picks the ad, the deep link in it is run by the user device. Clearly, there is no need for a network call to the Registry to get the deep link. However, this variant is suboptimal compared to a configuration where the ad does not have the deep link. If a user clicks on an ad linket, causing a message to be sent to the Registry with that linket, then the Registry can record that the ad was clicked on. In one arrangement, the Registry can get paid extra if the user clicks on the ad. Separate from when or if the Registry gets paid to show the ad.

When the Registry records an ad being clicked, it could also inform the owner of the ad in near real time. Or it could batch these and later send the results to the ad owner.

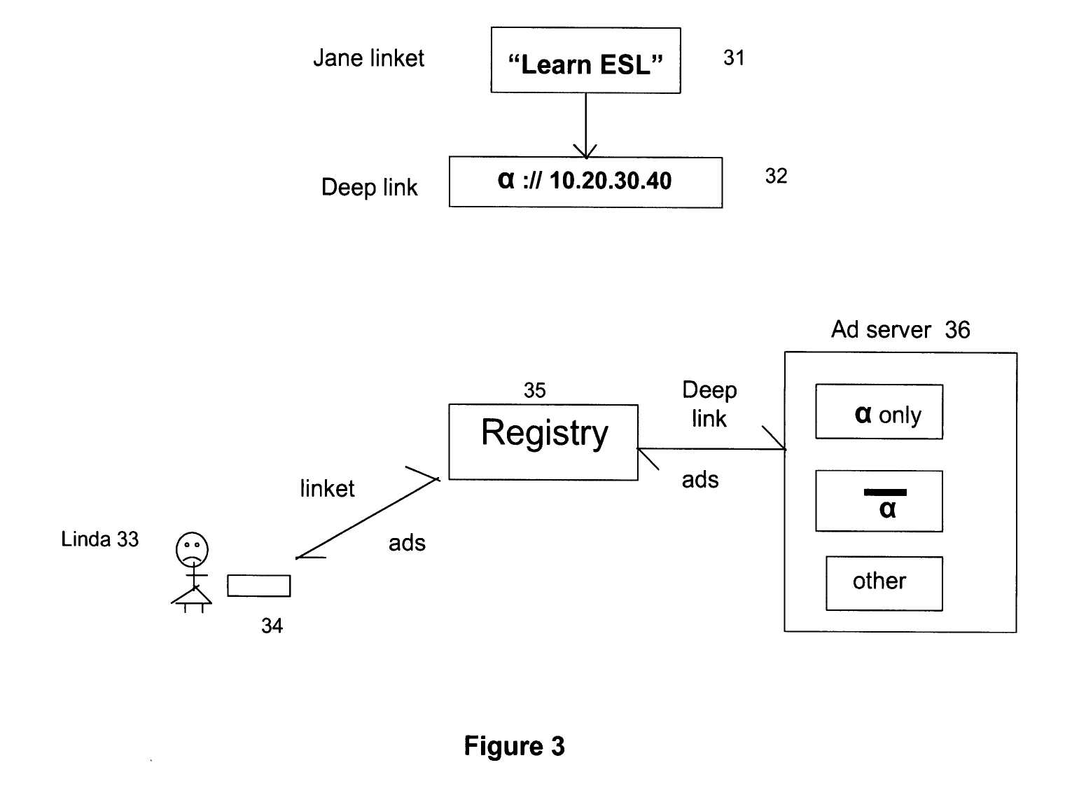

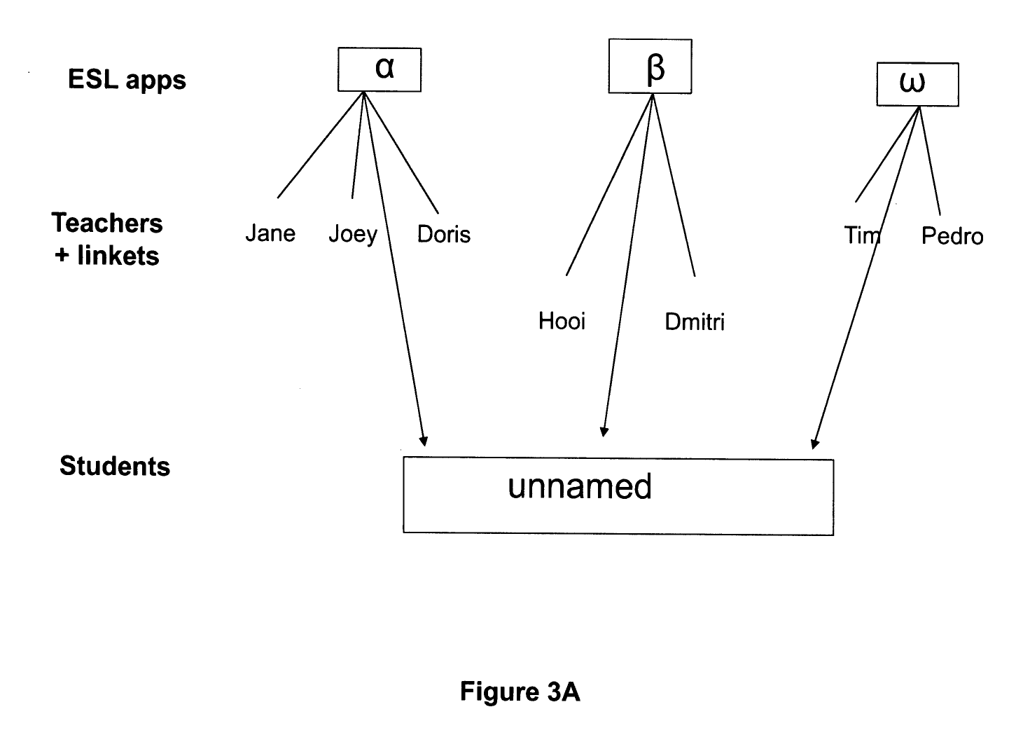

See FIG. 3. Item 31 is Jane's linket, “Learn ESL”, which maps to item 32, the deep link Alpha://10.20.30.40. This mapping is held in Registry 35. Here we suppose 10.20.30.40 is the network address of Jane's device. There is an app instance running at that address, listening at some port number for a network query. For simplicity, the app on Jane's device might be Alpha or another app compatible with an Alpha instance interacting with it.

Now imagine a user Linda 33 with her device (typically mobile) 34. She gets linket 31 by some means. For example, she might use her browser to show a web page that has the linket. Her browser is modified so that the linket is shown as a clickable link. This web page could be one that shows many linkets on a subject that Linda is interested in studying. Or a friend might have sent her an email with the linket in the body of the email. Her friend knows that she is interested in ESL and her friend has used Jane's service and recommends it in the email. Linda uses her browser to read the email.

If Linda clicks the linket, her device sends it to the Registry. We say “her device” because the browser modification may also involve changes at the operating system level. The net effect is that the linket is sent by the device.

Her device wants the corresponding deep link. The Registry converts the linket to deep link 32 and sends the latter to the ad server 36. Or it might send only the app id Alpha in the deep link. The ad server, considered as a database, can be held inside the Registry or it might be an external database. Purely for display clarity in the figure, it is shown outside the Registry.

The ads that correspond to Alpha can be divided into 2 groups, shown as “Alpha only” or “not Alpha”. The thick horizontal bar over the lower “Alpha” designates a Boolean “not”. The Alpha only ads are ads by competitors to Jane, where they also use Alpha to teach the subject that Jane is teaching. The not Alpha ads refer to ads that use other apps. Preferably these apps are also for teaching Jane's subject.

But they do not have to be. An extension is to add another category to ad server 36, labelled ‘other’ in the figure. The not Alpha ads might now be ads for apps that are not Alpha and teach ESL. While the ‘other’ category is for ads on other subjects. These however might expect fewer clicks. The ‘other’ ads are not contextual ads.

The ad database picks zero or more ads from the groups and sends these to the Registry. Which in turn sends these to Linda's device for display. If Linda does not pick any and perhaps closes the window in which the ads appear, or if she picks an appropriate button in the ad window, then this sends a signal to the Registry, which can then send Linda deep link 32. If Linda picks an ad, then the Registry can send the appropriate deep link for that ad.

One criterion for picking the ads is to use any geographic information about Linda, from her network address. Preference can be given to ads about linkets close to her, to reduce latency in her interaction. In this case, FIG. 3 can be amended so that the Registry also sends her approximate location to the ad server.

FIG. 3A shows a configuration. At the top level are 3 apps, Alpha, Beta and Omega, for teaching ESL. The second level shows various teachers who have linkets that use these apps. Jane's linket uses Alpha, and so does Joey's linket, for example. The third layer refers to students, who also use those apps in student mode. The teachers compete with each other for students. Of course, there would be links between the teachers and their students. These

In general, linket owners do not own the apps that they use. The app companies stand separate from the linket owners. The reader should keep this in mind.

3.1: Example of a Linket Ad;

An ad can have several parts. One is the linket, showing its text content. Because the point of the linket is to have a text label that is short and semantically meaningful to a human reader. The ad can also have an accompanying text as extra information. The ad might also have small images. One image can be that associated (or part of) the linket, if the Registry lets a linket have an image. Another image could have been associated with the extra text.

If the Registry allows images in the ad, there might be restrictions. If Linda has made queries to the Registry before, and it knows something about her device, then she might have asked the Registry to not show images in the ads, to reduce her bandwidth use and power consumption.

Regarding images—a linket might in some implementations also have images that are considered part of the linket data. These images might be shown in the ad.

The ad might also have a rating of the linket owner (advertiser). This comes from the Registry's records of the owner's earlier interactions and feedback from users. The rating gives guidance to Linda, helping her decide whether to pick that ad or not.

The ad could have a selectable link or button with a label like “more”. If Linda picks this, the ad shows more information. This might involve a network query back to the Registry to get that information. To reduce bandwidth in the original reply to Linda, the extra information could have been omitted from the ads.

An ad might also have the deep link corresponding to the linket in the ad. By default, the deep link would not be shown, to reduce visual clutter. The display of the linket in the ad could let Linda mouse over it to see the underlying deep link, much like seeing an URL in a browser. However, as discussed above, the Registry has good reason not to show the ad deep link at this stage of user engagement.

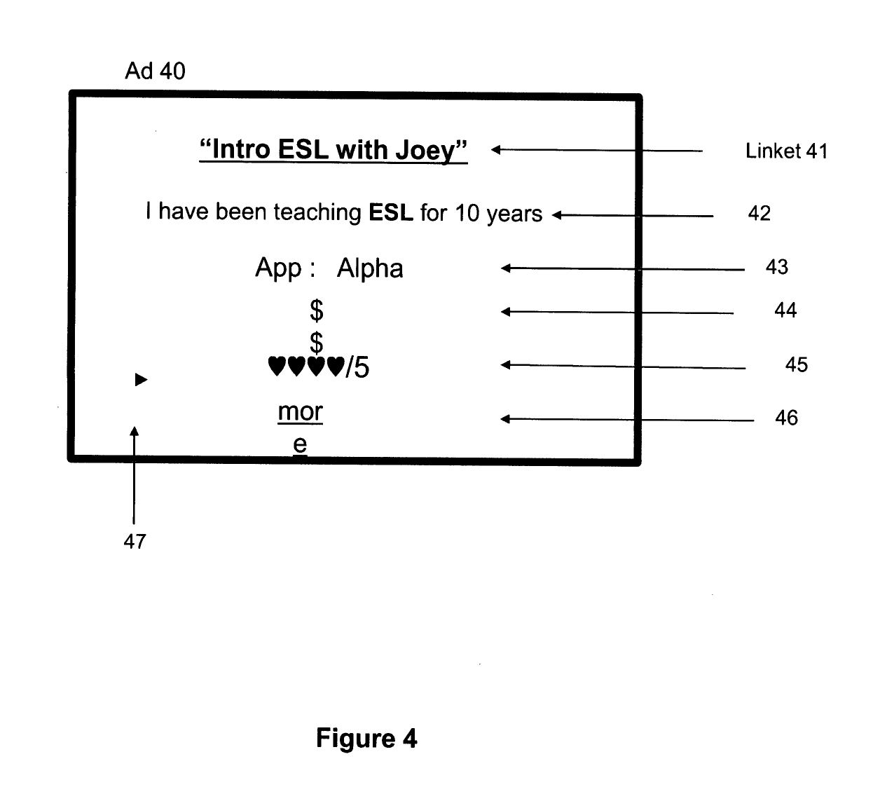

FIG. 4 is an example of an ad. Item Ad 40 appears in or as part of a window on Linda's device. Linket 41 is a linket being advertised to teach ESL. This linket from Joey competes with Jane's ESL linket, which was the one originally picked by Linda. The underline symbol under the text indicates to Linda that she can click this. Similar to the display convention for standard clickable web links on many web pages for a web browser. Item 42 is some explanatory text about Joey that accompanies the linket. Item 43 explicitly names the app used by the linket. Item 44 is symbols that indicate the cost (if any) of the app. The currency symbol here is the dollar. For other countries or regions with other currencies, different appropriate symbols should be used. The more the currency symbol is repeated, the more expensive the app.

The currency symbols can be replaced by more elaborate symbols for the case where the app is initially free. This case has several subcases. One is where after some time of the (new) user using it for free, a cost is imposed. Another subcase is where there are ads, perhaps in lieu of the user paying a fee. Another subcase is where the app offers to “upsell” items to the user. The latter is often in the context of a game, where the items are game items useful to the player. None of these are depicted in the figure, for simplicity. But graphic notation might be devised for the cases if necessary.

Item 45 is a rating. The heart symbol designates a favorable level. In this example, the maximum rating is 5 and the linket has 4 out of 5, which might be considered good by Linda. The rating might come from a summary of ratings submitted by users of the linket to the Registry.

Item 46 is a selectable link “more” that will show more information about the linket and its owner.

Item 47 is an audio “play” button. This is the standard symbol for playing audio or video. If Linda clicks this, a short audio can play, with an example of Joey's fluency in English. If the audio is not already in the ad, then her device contacts the Registry to get the audio. In this case, the Registry can record that the audio was requested by the user. It can tell the advertiser. In some uses, this by itself might be important to the advertiser. For example, if the ad is about music, then the audio could be a snippet of a band's new song.

FIG. 4 is only an example. Depending on circumstances, some of the items can be omitted or other types of data could be shown. For instance, a photo of Joey could have been shown (assuming he furnished it to the Registry).

One variant is where Joey could have made several versions of the ad. Which version gets downloaded to the user can depend on the user device address. When the Registry gets the query from the user, it extracts the address that the query came from (from the Internet packet). It could map this to some region. Like China. Then Joey might have given instructions to the Registry in his ad, to show a given version if the user is in China. Since the subject is ESL, then the text in the ad could be mostly or in part in Mandarin. And if his ad has audio, there might be an audio track mostly or in part in Mandarin. This track would be downloaded to the user device if she clicks on the audio button in the ad.

Given the success of Google with its contextual ads, it can be expected that the first 2 categories shown in FIG. 3 are contextual ads and thus more likely to be picked by Linda.

3.2: Linket Changes App;

A major extension to the above is for the Registry to keep track of linkets, when the linkets change the apps in their deep links, under orders from the linket owners. We described one scenario of this in the previous section, where a linket owner wanted to upgrade an app or to use an entirely new app. (For presumably the same business purpose, like ESL.) During this recommended app change, it might be useful for competitors to advertise their apps to users.

Consider the earlier case in the previous section, where Jane, a linket owner, changed her linket from using Alpha app to Beta app. There are several possibilities for competitors. Here the competitors are considered to be persons (or companies) owning linkets, and not the companies that own the competing ESL apps. This change by Jane to her linket can be a critical point in the interaction of a user with the linket and Registry. Analogous to when a person wants to buy a new car. She might be tempted to go with a default plan of getting a new model (upgrade) of her existing car. But car dealers know that this can be a fruitful time to pitch her a car from another manufacturer.

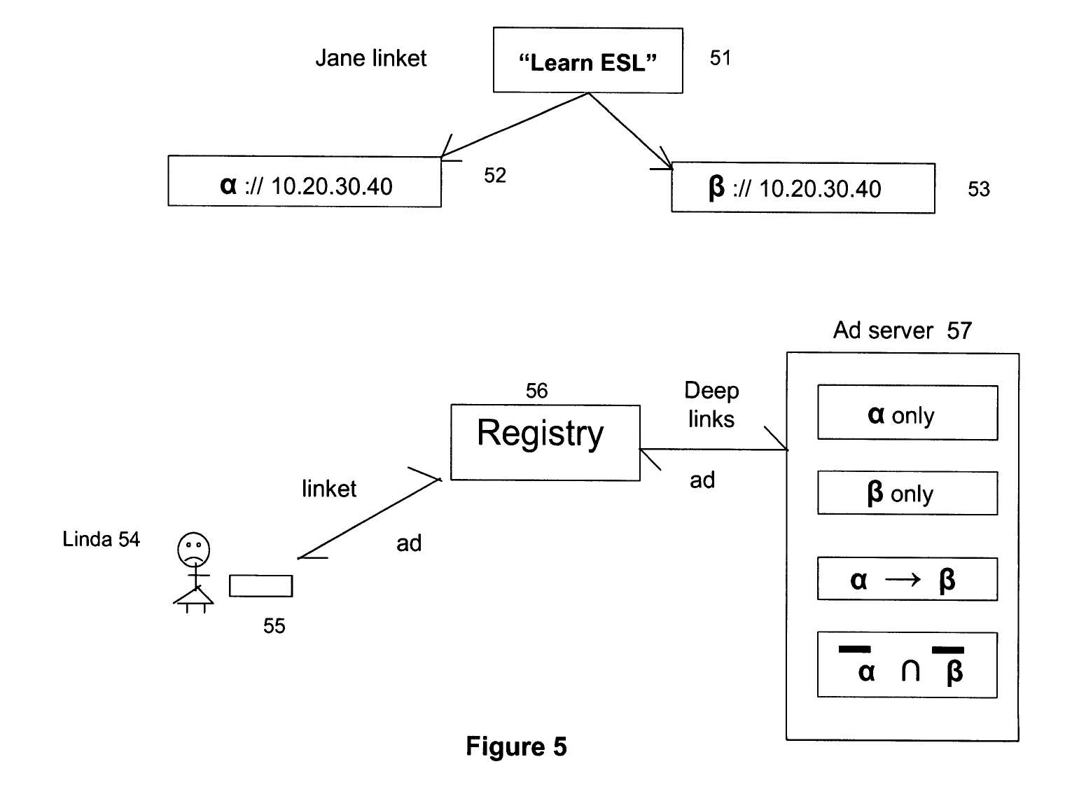

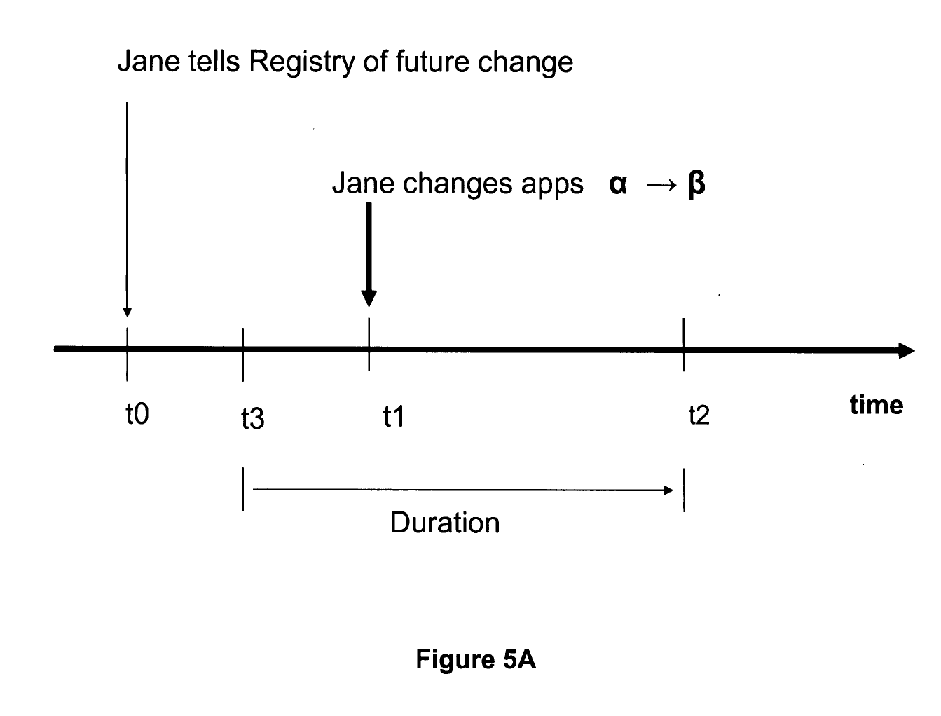

See FIG. 5. This shows Jane's linket as item 51. At first, it points to item 52, which uses the Alpha app. Then Jane tells the Registry 56 to point the linket to item 53, which uses the Beta app. In the deep link examples, her network address is unchanged. In general, it might also change. But the figure depicts it as unchanged to focus only on the change in the app, which is the crucial point here. Her linket is unchanged during all this.

After this transition, a user Linda 54 and her device 55 get the linket. As earlier, this might be by the linket appearing in a web page, and the linket is unchanged.

Device 55 sends the linket to the Registry, which contacts ad server 57. The Registry sends the ad server not just the new deep link 53 but also the previous deep link 52. Hence the label “Deep links” uses the plural form. Though in practice, the Registry might only send the ids of Alpha and Beta for brevity. There might be no need for the ad server to know the network addresses in the deep links. This follows the idea of minimising the transfer of parameters between modules, to make each module more independent and robust. However, the figure still depicts “deep links” on the label to emphasise the idea of deep links.

In one case, a competitor to Jane still uses Alpha. The advantage this competitor can offer is that a user already using Alpha does not have to learn a new app. This exploits a likely reluctance of some users to learn a new app when they have already invested time in learning a first app. Here, the competitor does not care what the new app is. This is shown as the (unlabelled) item “Alpha only” in 57.

In a second case, a competitor is using Alpha, but its message targets the transition to the specific new app, Beta. The message might describe some presumed disadvantages of using Beta vis a vis a continued use of Alpha. This is included in the “Alpha only” item. Though the contents of 57 could be amended to explicitly include this case as a separate item.

In a third case, a competitor to Jane is using Beta. That is, the competitor is using the same new app. Here, a competitor might say in its ad message that it is experienced with the new app. Here, the competitor's message might not care that Jane is coming from Alpha. This is the unlabelled item “Beta only” in 57.

In a fourth case, a competitor is using Beta but explicitly targets users who are currently using Alpha. This case is directed at the specific transition between those apps. This is the unlabelled item “Alpha to Beta” in 57.

In a fifth case, a competitor is using a third app, Phi, different from Alpha and Beta. (Phi also teaches the same subject.) The competitor might play up some thing that Phi has or does that is purportedly better than both Alpha and Beta. In 57, this is the unlabelled item “not Alpha and not Beta”.

This case might be split further, like the earlier cases. Into where the competitor does not care about specific properties of Alpha or of Beta. Or where the competitor makes specific claims about Phi being better.

Of course, in each of the above cases, there might be several competitors. The Registry can let other linket owners bid for the right to present themselves in ads to users, when the users are facing (or will be facing) possible new app installs.

The duration of the transition, during which the ad server uses the information about the new and old apps, to find and present ads, can be found or defined by various means. This duration can differ for different types of ads. The ad server could use methods external to this submission to define the durations.

After the duration, when the Registry uses the new Jane deep link that has Beta, the ad server might consider grouping the ads as in FIG. 3, where the Alpha in that figure is now the current app Beta.

But suppose in this duration or after, the Registry gets a raw query that is just the old deep link 52, that refers to Alpha. The ad server might still use the groupings in item 57. This accounts for the cases where a user directly has a copy of Jane's deep link that pointed to Alpha.

For the groupings in FIGS. 3 and 5 to be made by the ad server, it needs knowledge of the apps. And for the case of FIG. 5, it needs knowledge of when the transition starts. This comes from the Registry but is not shown explicitly in the figure.

FIG. 5A shows the transition in Jane's linket. The line depicts time, increasing to the right. At time t0, Jane tells the Registry that at a later time t1, she wants her linket to change from using Alpha to using Beta as its app. Jane might want some time for her to, for example, directly contact her existing customers, to alert them that she wants to change her app at the future time t1. She can give them some reason why she is migrating. We suppose here that she has the electronic addresses of some or all or her existing customers. If so, she should do this, to avoid any unpleasant surprises for them.

For people who are not yet her customers, she cannot contact them. But when her linket changes at time t1, and they use her linket for the first time after t1, then they will never have interacted with her via app Alpha. So not being able to contact them at time <t1 is moot.

The Registry might impose on Jane that if she wants to make the above change, that she do so at a minimum time interval (e.g. one hour) before when she wants the change to occur. There might be exceptions to this for various reasons. One is that a bad flaw was discovered in app Alpha, perhaps of a security nature. And all users of Alpha are strongly advised (maybe by a computer security firm or body) to immediately discontinue and migrate to Beta. So t0=t1.

The time interval (t1, t2) can be considered the duration for showing competing ads that we discussed above. Where the duration commences when the actual change of apps happens. More broadly, the duration can be extended to some lower time t3, where t0<t3<t1.

A reason for having the duration start before the transition at t1 is to let competitors show ads as soon as possible. The Registry can benefit by charging the competitors for as long a time interval as possible around the transition time t1. Given this, FIG. 5A suggests that a default policy for the Registry is to define t3=t0, to maximise the lower bound of the duration.

When a user device contacts the Registry with the linket, the Registry can reply with an ad. The ad can show one or more of the above types. For each type, the ad can show one or more competitors. Perhaps with a brief description of each competitor.

When Jane told the Registry of her transition, the Registry can make this information searchable by other linket owners. Or even by the general public. The heads up lets the owners craft ads referring to the transition, to persuade Jane's users to migrate to their linkets. Some owners might already have ads prepared, that are not specific to her linket. For example, an owner who uses app Alpha, and is not migrating from it, can make an ad that says “I am still using Alpha. No need to learn English from another app.” This ad can go into the group of ads that refer to Alpha, and which do not refer specifically to Jane's linket.

Likewise, an owner who uses Beta might be aware of Alpha as a competing ad. He does not know specifically of Jane migrating from Alpha to Beta. Before Jane told the Registry of her move, he already made an ad about his expertise in teaching with Beta. And how Beta is “better” than Alpha. He sends this ad to the Registry prior to Jane telling it of her move. The Registry can pre-populate the “Alpha to Beta” ad group with ads like his.

In the above, we described Linda and her device 55 sending linket 51 to the Registry. During a transition period, the Registry picked ads from the choices in ad server 57. But how does the Registry know that Linda was earlier using the linket where it pointed to Alpha? It might not. In this case, it can still assume that Linda was using Alpha, and so pick from the ad groups in 57. Or the Registry could just use the knowledge that the linket now points to Beta. So it picks from the group Beta only and maybe the group not Alpha and not Beta in 57. Or it devolves to the case of the previous figure, where Alpha in that is now Beta.

The Registry could have prior knowledge of Linda's earlier queries to it. Much like Google can record the queries it gets from a given network address. So the Registry might know that before the transition, Linda had sent it linket 51 when it mapped to Alpha.

The prior knowledge does not have to be of queries from the exact current network address of Linda. The Registry could aggregate queries from a network neighbourhood of her network address. If before the transition it got several queries with linket 51, then even if there was no previous query with the linket from Linda's address, it can assume prior use of Alpha. And then it proceeds with using the ads from the ad groups in ad server 57.

Using the old app and the new app, the Registry or ad server can automatically make categories of ads from competitors. Plus, the Registry can check when a competitor puts its ad into one of the categories. The ad will or should have the competitor's linket. The Registry already knows the app referred to by the linket. So the Registry can compare the app to Alpha and Beta from Jane's linket.

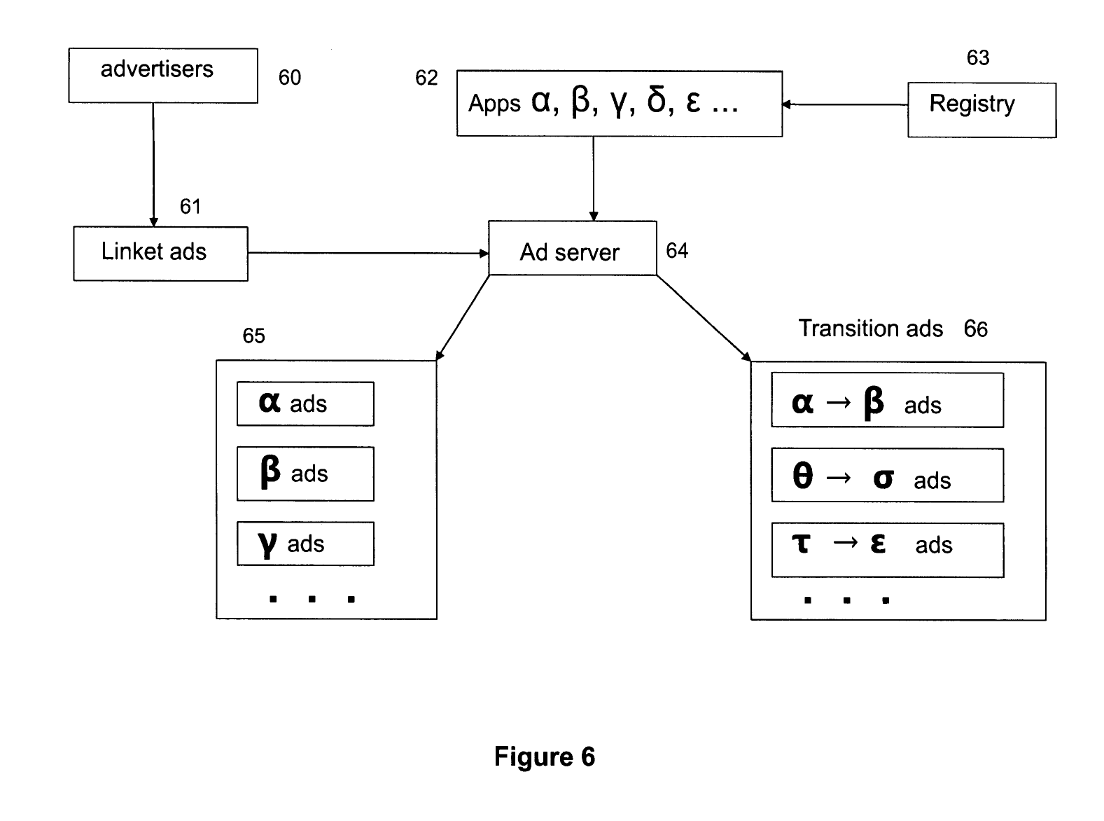

This is shown in FIG. 6. The linket owners (who make ads) and their devices are depicted as “advertisers” in item 60. Item 61 is the linket ads, sent from advertisers 60 to ad server 64. Ad server 64 also gets as input the deep links (or the ids of apps in those deep links) 62 that are in existing linkets. Item 62 can come from the Registry 63. The ad server can make various tables. The most important and straightforward is item 65. These are the linket ads that only refer to a given app.

The ad server can also make a transition table 66. These are ads that refer to linkets that are moving from one app to another. For example, suppose there are apps Theta and Sigma as shown in item 66. Some linket owners define a migration of their deep links from Theta to Sigma. Other linket owners can then write ads for this transition. These ads can be for a linket that uses Theta exor Sigma. Or even for linkets that do not use Theta or Sigma. This latter case could be where the owners of the linkets suggest that their apps or their use of these apps are superior to Theta and Sigma.

FIG. 6 extends FIG. 5 by taking a broader view across all types of apps and ads about those apps.

An ad can be in several tables in FIG. 6. For example, suppose for linkets that use Alpha app, some linket owners want to migrate to app Beta. Other linket owners using Alpha will migrate to app Eta. (Eta is not shown in the figure.) Then consider an ad for a linket that competes with the previous 2 groups. This ad continues to use Alpha. It has text that emphasises that it is not migrating. The ad might end up in a transition group for Alpha to Beta, and also in a transition group for Alpha to Eta. The author of this ad might simply be able to pick a type=“stay with Alpha” (or words to that effect) when she is uploading the ad to the Registry or ad server. The web page or app that the author is using to write and upload her ad could offer this option.

The ad server can programmatically assign the ad to the “Alpha to Beta” group and also to the “Alpha to Eta” group. In turn, the Alpha to Beta group can have a subgroup for “Alpha only”, that holds ads when the app is Alpha.

FIG. 6 has another feature to aid the above. Advertisers 60 send ads 61 to the ad server 64. The advertisers might first get data from the ad server, letting them look at existing ads that refer to app Alpha. An advertiser 60 that continues to use Alpha can see if any linkets are transitioning and if so to which other apps. The advertiser can also see ads about linkets that continue to use Alpha. This helps her write her ad and also to manually decide if she wants her ad to be in transition groups. And to manually override any default programmatic methods used by the ad server to assign her ad to transition groups or subgroups.

These uses demonstrate an app social network. One graphical representation of the network might use apps as the nodes. And a transition from say app Theta to app Sigma would be a directed link between those nodes. The weight on that link can be a function of time or of a time interval, showing the cumulative number of ads of that transition that were downloaded to user devices.

3.3: Search the Ad Server;

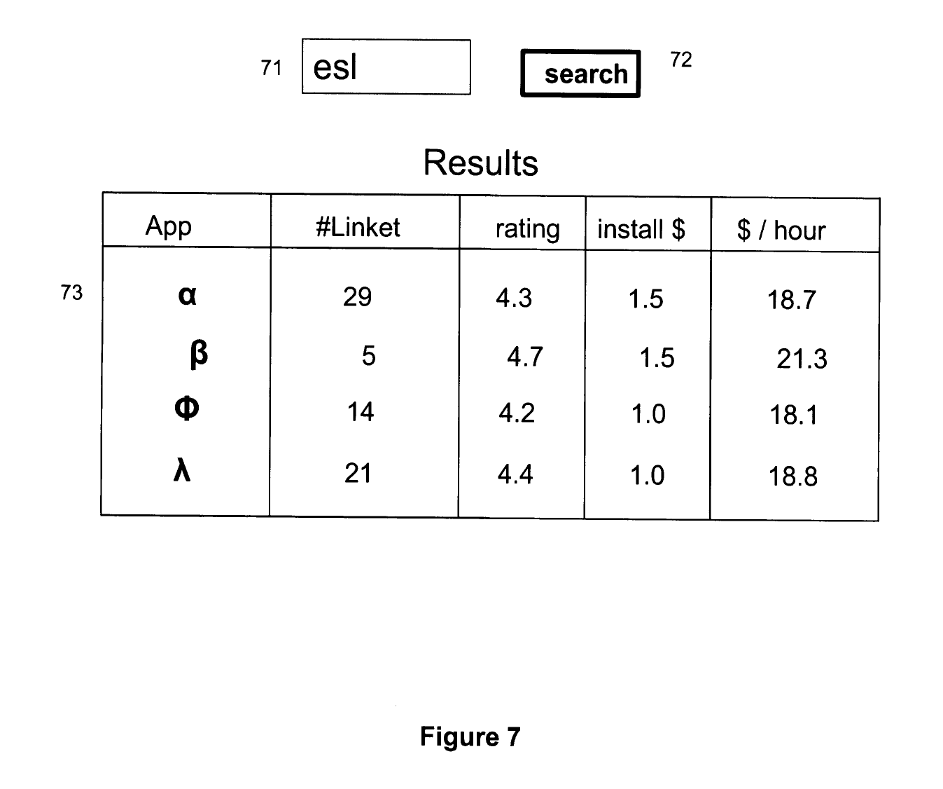

FIG. 7 shows an example of what an advertiser might see from ad server 64. This can be in a web page or special app made by the ad server. Item 71 is a search box, in which she types a topic that linkets might address. In this case, she has typed ‘esl’. Item 72 is the search button. Upon pressing it, ad server 64 returns table 73. The App column shows the names of 4 apps that teach ESL. The #Linket column gives the number of linkets that use a given app or are transitioning from that app. We see that app Alpha has the most linkets, 29. So the number of linkets using a given app can be a measure of the success of that app in the marketplace vis a vis competitors.

The rating column gives an average (in some mathematical sense) rating of the linkets, in a range from 0 to 5, where 5 is the best. The “install $” column is the cost of installing the app. The “$/hour” column is the average hourly rate that the instructors charge students. Notice that the install cost is the same for all linkets using a given app, while the hourly cost can vary because different instructors using the same app can charge different rates. We assume that the ad server (or Registry) lets instructors charge whatever rate they wish.

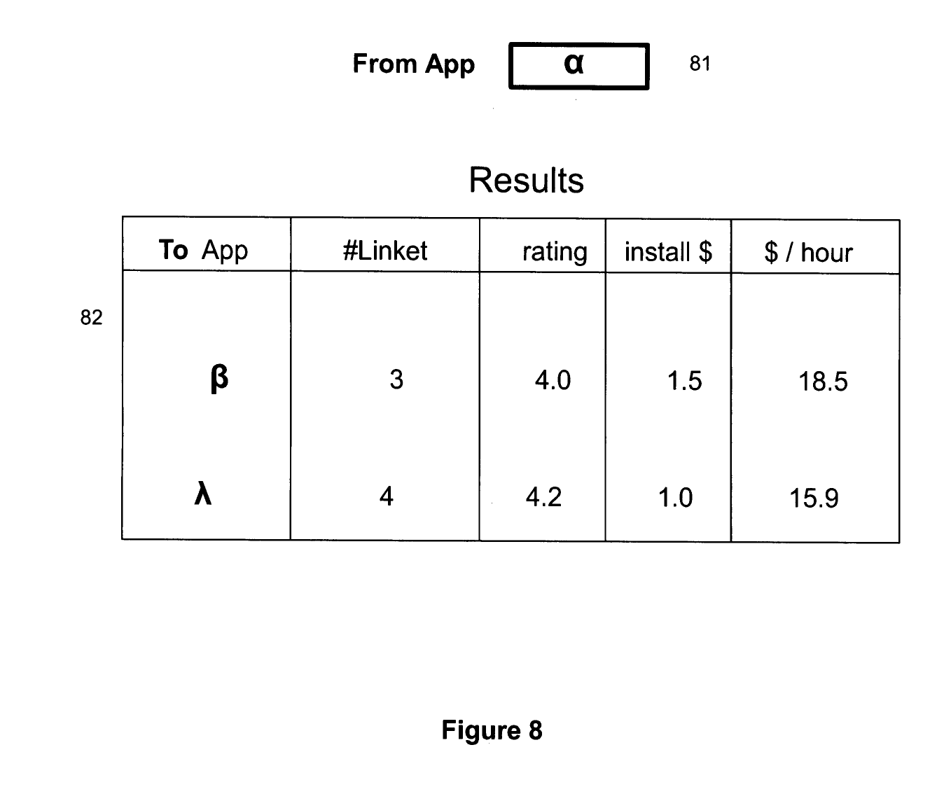

Now suppose the advertiser picks Alpha in table 73 and wants to see the linkets moving away from Alpha. FIG. 8 shows the results. Item 81 is a box listing Alpha as the “From app”. Item 82 is a table of the To apps. App Beta has 3 linkets that use Beta and were using Alpha. App Lambda has 4 linkets that use Lambda and were using Alpha.

The tenses in the previous paragraph are somewhat mixed. The results in FIG. 8 might also be for linkets that are currently using Alpha but are scheduled at some future and soon time to use other apps. There can be graphical options in the window seen by the advertiser that let her more precisely drill down into subsets where the transitions have all happened etc.

Each line in table 82 might let the advertiser pick it and drill into showing more details about the linkets that are moving to that app from Alpha.

Item 81 could be a drop down menu or have other options that let the advertiser alter the depicted Alpha and pick another app as the From app.

The advertiser can pick a given line, for a given app, and then click on it to give more details about the linkets using that app.

Other types of transition tables more involved than item 66 are possible.

FIGS. 7 and 8 might also be used by the general public. A user could search a topic and see what are the most popular apps. Measured in part by how many linkets each app supports. She can drill down and see the cost charged by various teachers, and ratings of those teachers by students.

3.4: Write a Linket Ad;

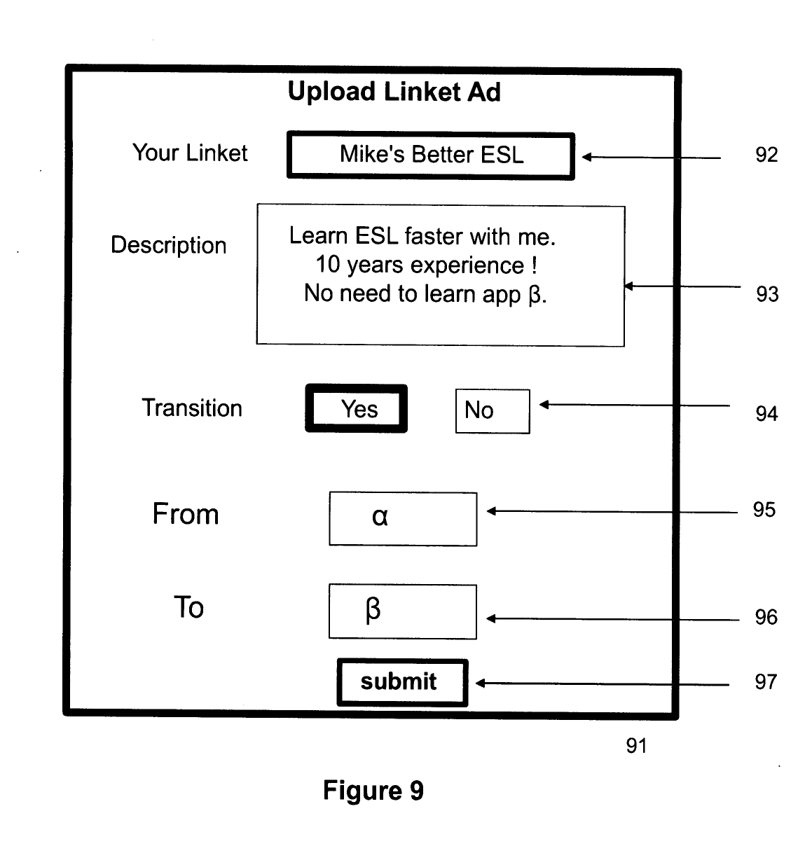

FIG. 9 shows an example of a graphical window 91 in which the owner of a linket can place a linket ad. Item 91 can run in a web page or in an app. Item 92 is where the linket owner writes the linket. Not shown in the figure is that the example linket written in 92 is assumed to use the app Alpha.

Item 93 is text blurb that accompanies the linket. Item 94 is a choice of one of two buttons—yes exor no. The buttons can be considered as radio buttons in a GUI widget pair. The owner picks yes, as shown here, to indicate that he wants his ad to address the transition between 2 apps. By picking yes, this lets the ad server put the ad into the transition group in FIG. 6.

If the user pressed yes, then items 95 and 96 appear. They depend on this choice for item 94. Item 95 is where he writes the From app id. Item 96 is where he writes the To app id. Item 97 is the submit button. The user presses this to upload the ad to the ad server. The device that shows window 91 can be a desktop, laptop or mobile device.

If Mike (the linket owner) leaves item 96 blank, this can be for the case where his ad is for any transition of another linket from using Alpha to using any other app. In this case, he should amend the text in item 93 to not refer to app Beta.

Similarly, suppose Mike's linket uses app Beta. And he wants to handle the case of any competitor who is transitioning with her linket from using any other app to using Beta. He would write Beta in item 96, as shown in the figure. But he would leave item 95 blank, to tell the ad server that he is referring to this case.

FIG. 9 can have more options, which might be implemented as a second screen of options. These options include whether to restrict the linket ad to some geographic region of the person querying the Registry (and the ad server). But in FIG. 9, we focused on the key aspects that differentiate this ad from possible ads in the prior art. Which we consider to be the grouping of ads into various classes. Where the classes are defined by an app or a transition between apps. This harks to the underlying structure of our linket and deep link.

FIG. 9 should be compared to FIG. 4. They are closely related. FIG. 9 is for defining and uploading an ad to the Registry or ad server. FIG. 4 is how that ad might be displayed to the end user.

The restriction to a region can be considered a location based ad feature, and there has been much work done on this in the last 10 years.

Likewise, other options that could be added to FIG. 8 include parameters for payments. As discussed earlier, there can be various (many) types of ways that the ad server (or Registry) can structure how ads are paid for. A flat fee for showing the ads for a fixed number of times can be the simplest arrangement. More complex plans are possible.

An option not depicted in FIG. 9 is where Mike is able to “attach” his ad to a specific linket. If the latter changes its app, then Mike wants his ad to be shown. Or if that linket does not change, but someone sends it to the Registry, wanting its deep link, then Mike wants his ad to be shown.

What would happen if the user picked “No” for item 94? Items 95 and 96 would not appear. There is now no context for these. Instead, when the user submits the form, the ad server would take the linket written in 92, ask the Registry and find that the linket maps to a deep link using app Alpha. The ad server can put the ad into the Alpha only group in item 65 of FIG. 6.

The value to competitors of this section is the specific nature or context in which they can place their ads.

3.5: Location Based Ad Options;

There are extensions where the competitors can apply other criteria. Perhaps location based, if the Registry can get information about the user's location. Some competitors might only want their ads shown for users in a given region, as defined by a geofence perhaps. There has been much prior art on the use of geographic targeting of ads, based on user location. Thus the present submission does not dwell further on this.

Another use of location is via the network address in the deep link. This refers not to the user device which sends the query with a linket or deep link, but to a separate device owned by the owner of the linket. By mapping that network address to a geographic location, this acts as another factor in FIGS. 3 and 5 to determine what ads to show. So for the ESL example, if a teacher like Jane is in the US, the ads might be found in part by picking ads that use her American location.

3.6: Block Competing Ads;

An extension is where Jane can pay the Registry not to show ads from competitors. To reduce the risk of her clients defecting. The Registry might let the decision of how much Jane can pay be made via an auction-type mechanism. The amount Jane pays can be determined by the total fees paid by the competitors whose ads are shown, if the ads are to be shown.

A variant of FIG. 5 is where the Registry gets the address of the device that sent the linket to the Registry, and sends this device address to the ad server. So when the ad server picks the ads, it can directly send the latest deep link and ads to the device. Instead of the ad server sending the data to the Registry, which then replies to the user device. The case of this paragraph is mostly relevant when the ad server runs on a separate device from the Registry.

One variant is suppose the Registry charges 10 cents to not show ads, for when Jane's clients sends Jane's linket to the Registry. If Jane pays the Registry $2, then for the first 20 queries for the new mapping of the linket to the deep link, ads are not shown. But for subsequent queries, ads will be shown. This 10 cents could be what a competitor would pay the Registry to show its ad.

The previous paragraph assumed that the fees paid by competitors for ads are the same 10 cents for each time when a Jane client presents the linket. But suppose the fees differ, because the ads chosen each time might differ. There might be some type of Real Time Bidding (RTB) available to competitors, and the winners each time might vary. Then one possibility is that Jane could pay $2 and this would be drawn down each time when a Jane client presents the linket. The amount drawn down could equal the value of the fees that would be paid in that instance by the competitors. When the $2 has been used up, future Jane clients will see ads from competitors.

The reader can appreciate that the variations on how ads are determined and what Jane can do are many. The above examples are offered as a flavour of the choices.

A word of caution might be in order. The Registry might want to restrict the number of ads it shows in response to a user sending in a linket. Having too many can dilute the effectiveness of each. Also, for reasons of reducing bandwidth to the user's device (which is likely to be mobile), each ad should be as small as possible. The example of the Google search page is notable. Results are often shown as simple text.

FIGS. 3 and 5 depict an ad server getting deep links (or their enclosed app ids) from the Registry, and then programmatically finding an ad or ads from groups of ads, where the grouping is determined by the app ids in the deep links. This finding can be aided by using any information the Registry might have about the user or user device that makes the initial query with a linket. The information might be triggered by a cookie (a pseuorandom bit sequence) that is part of the query, for example. The information is equivalent to what is currently used for many ads shown on desktop browsers (and often on mobile browsers), using RTB methods. Nothing about our earlier discussion in this section is meant to prevent the use of this extra information.

However, to the best of our knowledge, the RTB (or algorithmic auctions) prior art at the highest level differs from this submission. They likely do not use any knowledge about the existing app that the user is using, to group and pick ads from those groups. And for the case of a linket changing its deep link, the RTB prior art does not use knowledge of the old and new apps to group and pick ads.

Note also this about FIGS. 3 and 5. The ad server does not get the linket, at least in the above explanation. The ad server is not dependent on knowledge of linkets. It only uses deep links or the ad ids in those deep links.

One variant is where linket information is also used by the ad server. In turn, the groups of ads might be refined further given this data.

Another context where Jane might want to be able to block competing ads is when she transitions from one app to another in her deep link. Earlier, we described a time interval around this transition. In this interval, the Registry sends ads from competitors hoping to take advantage of her transition. She could act to reduce the time interval in FIG. 5A. The Registry could let her reduce the duration t2−t1, or t1−t3. How much it charges can be a function of how much she wants the duration to be reduced.

It could also depend on an estimate of what competitors might bid to show ads per unit time in this interval. The Registry may be able to derive such an estimate by looking at what competitors have paid it in similar recent cases. Or the Registry could conduct an auction, where the successful (highest) bidders do not pay yet. The total of these payments can be converted to some amount that Jane has to pay the Registry, for it not to show those ads.

While if Jane does not pay, then the bidders pay and their ads get shown.

A refinement of the previous sentence is where the ads might get shown first, and the bidders pay. In part, the amount they bid earlier might have been for a single showing of an ad. So the final amounts they pay, after the transition, depends on how often an ad was sent to a user device.

4: Linket Owner Actions;

Consider our linket owner Jane. She might have a top level linket which brings up a set of her other linkets. This could be accessed from the Registry by a query that gives the top level linket. Her linket then shows “sublinkets”. One is for her ESL teachings. Another sublinket is for her madcow gaming. A third sublinket could be for her playing bridge. A sublinket might functionally be just a linket.

This view of her top linket and its sublinkets differs from our earlier submissions where we showed a linket going to a table of linkets, where those were for different time slots to teach a subject.

Suppose for Jane teaching ESL with app Alpha, that she stays using Alpha. Indeed, she might have no idea that some of her competitors who use Alpha are migrating to other apps. When the Registry finds out about the latter, it might wait until some minimum number of linkets have or are planning to move from Alpha. Then it can send messages to Alpha users like Jane, telling them of this. This can be valuable business intelligence for Jane, for which the Registry might charge a premium.

Suppose Jane wants to delete her ESL linket. She sends a command to do this to the Registry. It checks her other linkets and sees that none are about ESL. It can advise her that other ESL linket owners are using other apps or are migrating from Alpha. It can tell her what those other apps are. This might induce her to stay and keep using her ESL linket. Or to use another ESL app that she now points her linket to. By staying, the Registry can keep getting revenue from her for teaching her subject.

Suppose ultimately Jane deletes her ESL linket. If the Registry gets future requests with that linket, it can forward those to other linkets. Using Alpha as the app or using another app. When a linket is deleted, this means that the Registry will no longer map from the linket to the deep link that the linket pointed to. It does not mean that the Registry deletes all data about the linket and its owner from the Registry database.

This forwarding to other linkets is another revenue source for the Registry. It can auction off the referrals that refer to expired linkets. Existing linkets (i.e. their owners) can bid for traffic about those expired linkets. The fact that there are expired linkets means less competition for the remaining linkets on the same topic as an expired linket. Earlier cases were for an existing default competition from a linket owner. A user who had already used the linket might by default stay with it. Now when the linket is deleted, she has no choice but to migrate.

Another scenario is where Jane transfers ownership of her ESL linket to another entity. The Registry or the ad server could have ads specific to that linket, advising users that ownership changed, and giving a list of other linkets for the same topic. More generally, at any time, the Registry could for each topic let (the owners of existing) linkets bid to show ads directed at users going to expired linkets. The ads can be in 2 groups. One group uses the same app as was in the expired linket. The other group uses other apps that are for the same topic as the expired ad. Both groups have contextual ads.

One reason for the Registry having 2 groups is that it might charge them different amounts. The first group with the same app might have a better chance of uptake from the users if the latter have already used the expired linket with that app. These users do not have to learn a new app. The Registry might argue that because of this, the first group should pay more to show their ads. The second group pays less because its ads could have less success. The Registry can let existing linkets bid for the right to show ads to users going to the expired linkets.

There are nuances. Perhaps the first app is objectively harder to use than other apps for the same topic. (Maybe this was why that linket owner who used the app is abandoning it.) The Registry might encourage linkets using other apps by letting their ads show for less.

This use of 2 groups can also be applied to the earlier case where Jane deleted her linket. One group uses the app in her deleted linket. The other group uses other apps.

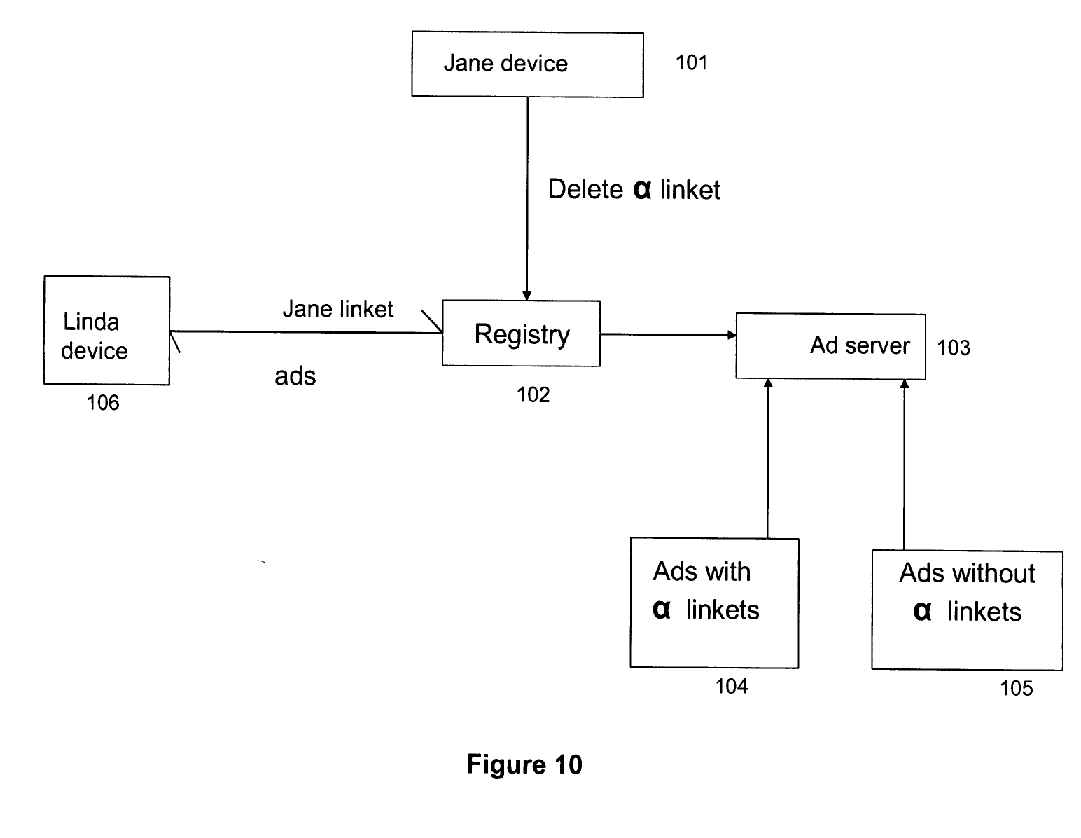

See FIG. 10. Item 101 is Jane and her device sending a command “Delete Alpha linket” to Registry 102. The Registry does this and contacts Ad server 103. The latter makes or more likely has 2 groups of ads. Item 104 being those ads with Alpha in the linkets. And item 105 being ads without Alpha in the linkets. At some later time, Linda and her device 106 send Jane's deleted linket to the Registry. The Registry replies with one or more ads from 104 or 105.

Aside from revenue the Registry gets from those ads, in a longer perspective the Registry does not want users to send it an expired linket and it replying with “Sorry, no data”. This can turn away users from making other linket queries at other times.

The point is that the changing of ownership is a possible place where the customer base can be vulnerable to changing its teachers and apps.

In turn, the Registry could let a new owner of an existing linket pay for those inducing ads not to be shown.

Related to the actions of deleting a linket or transferring its ownership is where Jane has her linket point to another owner's linket or deep link. Jane does not actively run an app to service queries to her linket. This action can be considered an aliasing action. For this, the other owner can pay her. But this action can also trigger the Registry making ads by competitors of both her and the other owner.

Here, suppose Jane was previously using app Alpha. Now her linket points to another linket that uses Alpha. The ads could still refer to this effective change of ownership of Jane's linket.

Another case is where the other linket uses a different app. Then the case we discussed earlier of Jane migrating from Alpha to Beta can be applied here. Where the competitors ads can point to 2 differences. The change of the apps. And the change of ownership. Both differences can be exploited by competitors to draw away Jane's students.

We claim:

1: A method of a Registry server associating a first linket with a deep link; where the first linket is a label of the deep link; where the deep link has an identifier of an app and an identifier of a network address of an app instance; where the Registry gets a copy of the first linket from an external device Beta; where the Registry replies with an ad; where the ad contains a first item and a second item; where when the Registry gets a reply indicating that Beta picked the first item, the Registry sends Beta the deep link corresponding to the first linket; where when the Registry gets a reply indicating that Beta picked the second item, the Registry sends Beta a deep link corresponding to a second linket.

2: The method of claim 1, where the first item has a deep link.

3: The method of claim 1, where the first linket has a topic; where the second linket has the same topic as the first linket.

4: The method of claim 1, where the second item contains a second linket; where the second item contains additional text and selectable elements representing audio or video data.

5: The method of claim 4, where the Registry gets the selection of an audio or video by Beta; where the Registry sends the corresponding audio or video data to Beta.

6: The method of claim 4, where the second item shows a rating of the second linket; where the rating is an aggregate of ratings of the second linket received by the Registry from users of the second linket.

7: The method of claim 1, where the Registry gets a monetary amount from the owner of the first linket; where the Registry omits ads from the reply sent to Beta; where the reply contains the deep link associated with the first linket.

8: A system of a Registry server and an ad server; the Registry getting a linket from a mobile device Beta; where the Registry finds the deep link associated with the linket; where the deep link has app id Eta; where the Registry sends Eta to the ad server; where the ad server picks zero or more ads from a first group of ads, referring to deep links with Eta; where the ad server picks zero or more ads from a second group of ads, referring to deep links with ids that are not Eta; where the ad server sends picked ads to the Registry; where the Registry sends picked ads to Beta; where the Registry gets an id of an ad selected by Beta; where the Registry sends a corresponding deep link to Beta.

9: The system of claim 8, where the linket is for a topic of instruction or interaction; where the second group of ads is for apps for the same topic.

10: The system of claim 8, where the Registry changes the linket from using a first deep link with app id Eta to using a second deep link with app id Nu; where the Registry gets a copy of the linket from Beta; where the Registry sends Eta and Nu to the ad server; where the ad server picks zero or more ads from a first group of ads with deep links using Eta; where the ad server picks zero or more ads from a second group of ads with deep links using Nu, the ads not having text referring to Eta; where the ad server picks zero or more ads from a third group of ads with deep links using Nu, the ads having text referring to Eta; where the ad server sends the picked ads to the Registry; where the Registry sends one or more of the Nicked ads lu Bela.

11: The system of claim 10, where the ad server picks zero or more ads from a fourth group of ads with ids of deep links using an app different from Eta and different from Nu

12: The system of claim 10, where the Registry gets a message from an owner of the linket, instructing the Registry to change the linket at a future time Psi, from referring to the first deep link to the second deep link; where the owner uploads the app id Nu to the Registry.

13: The system of claim 12, where for a time interval around Psi, the ad server picks zero or more ads from each of the first, second and third groups to send to the Registry.

14: The system of claim 13, where the time interval starts when the instructions from the owner of the linket are received and verified by the Registry.

15: The system of claim 10, where the linket is for a topic of instruction or interaction; where the second group of ads is for apps for the same topic; where the third group of ads is for apps for the same topic.

16: The system of claim 10, where the Registry gets location information about Beta from Beta; where the Registry sends the location information along with Eta and Nu to the ad server; where the ad server uses the location information as criteria to filter ads to be sent to the Registry.

17: The system of claim 10, where the Registry sends Eta, the address of Beta, and the second deep link to the ad server; where the ad server sends the second deep link and the picked ads to Beta.

18: A system of a Registry and an ad server; where the Registry marks a linket with a status of deleted, in a database; where the Registry gets the linket from an external device Beta; where the Registry finds an app id Eta associated with the linket; where the Registry sends Eta to the ad server; where the ad server picks zero or more ads from a first group of ads with ids of deep links using Eta; where the ad server picks zero or more ads from a second group of ads with deep links not using Eta; where the ad server sends the picked ads to the Registry; where the Registry sends the picked ads to Beta; where the Registry gets an id of a selected ad from Beta; where the Registry sends the deep link referred to by the selected ad to Beta.

19: The system of claim 18, where the deleted linket was for a topic of instruction or interaction; where the second group of ads is for apps for the same topic.

20: The system of claim 18, where the ownership of the linket is transferred to another entity; where the linket remains in the Registry.
